(19) United States
(12) Patent Application Publication
(10) Pub. No.: US 2017/0001839 A1
(43) Pub. Date: Jan. 5, 2017

(54) HIGH-SPEED AND FULL-DRIVE ELEVATOR

(71) Applicant: Shanghai Yangtze 3-map Elevator Co.,LTD., Shanghai (CN)

(72) Inventor: Zhiyong YANG, Shanghai (CN)

(21) Appl. No.: 15/198,489

(22) Filed: Jun. 30, 2016

(30) Foreign Application Priority Data
Jun. 30, 2015 (CN) 201510386423.6
Jan. 20, 2016 (CN) 201620049739.6

(51) Int. Cl. B66B 11/08; B66B 5/02; B66B 9/00

(52) U.S. Cl. CPC B66B 11/08; B66B 9/00; B66B 5/02

(57) ABSTRACT

A high-speed and full-drive elevator has a double-tractor full-drive structure installed inside the lift well, having a lift car, counterweight device, upper traction system disposed above the lift car, and bottom traction system disposed below the lift car. The upper traction system contains an upper wire rope, upper traction wheel and upper guide pulley. One end of the upper wire rope is connected with the top of the counterweight device. The other end is connected with the top of the lift car after passing through the upper guide pulley and upper tractor successively. The bottom traction system has a bottom wire rope, bottom traction wheel and bottom guide pulley. One end of the bottom wire rope is connected with the bottom of the counterweight device. The other end is connected with the bottom of the lift car after passing through the bottom guide pulley and bottom tractor successively.

### FIELD OF THE INVENTION

The present invention relates to elevator field, particularly relates to a high-speed and full-drive elevator.

### BACKGROUND OF THE INVENTION

Elevator is a type of vertical means of transportation under traction of tractor, which is also indispensable and important conveying equipment in carrying passenger and cargo in multi-story buildings and in high-rise buildings.

In current technology, as shown in FIG. 1, a traditional high-speed elevator applies single-tractor 13 as a drive part, and one end of a guide pulley 14 passes through a wire rope 12 and overhangs a lift car 11, and the other end overhangs a counterweight device 15, and the traction force generated from the friction between the wire rope 12 and the traction wheel groove drives the lift car 11 to move up and down. The disadvantage of such elevator traction structure lies in:
1. it applies high-power tractor which will substantially increase the cost of elevator;
2. single-tractor will easily break down, which will cause the whole elevator unable to be operated effectively.

### SUMMARY

The present invention provides a high-speed and full-drive elevator, which can effectively reduce the cost of electing and using tractor and improve the stability of elevator performance.

The present invention provides a high-speed and full-drive elevator, which applies double-tractor full-drive structure and is installed inside a lift well, it comprising: a lift car, a counterweight device, an upper traction system disposed over the lift car and a bottom traction system disposed below the lift car, wherein: the upper traction system comprises an upper wire rope, an upper traction wheel and an upper guide pulley, and one end of the upper wire rope is connected with the top of the counterweight device, and the other end of the upper wire rope is connected with the top of the lift car after passing through the upper guide pulley and the upper tractor successively;

the bottom traction system comprises a bottom wire rope, a bottom traction wheel and a bottom guide pulley, and one end of the bottom wire rope is connected with the bottom of the counterweight device, and the other end of the bottom wire rope is connected with the bottom of the lift car after passing through the bottom guide pulley and the bottom tractor successively; wherein,

the upper traction system and the bottom traction system are distributed respectively in the upper and bottom of the lift car in a symmetrical manner;

and in normal situation, the upper traction system and the bottom traction system are operated synchronously, to realize high-speed operation of the elevator.

As an embodiment, the upper traction system and the bottom traction system are controlled separately by different control systems, and the different control systems are communicated through optic cable, to control the synchronous operation of the upper traction system and the bottom traction system.

As an embodiment the high-speed and full-drive elevator further comprising a judgement mechanism, the judgment mechanism detects working conditions of the upper traction system, the bottom traction system and the control systems in real time when either of the upper traction system, the bottom traction system and the control systems is malfunctioning, the judgment mechanism controls the corresponding malfunctioning traction system or the traction system that corresponding to the malfunctioning control system to be deactivated, and makes another traction system to operate as emergency response.

As an embodiment, the upper traction system further comprises: an upper lift car wheel and an upper counterweight wheel, wherein:

the upper lift car wheel is installed on the top of the lift car;

the upper counterweight wheel is installed on the top of the counterweight device;

on the top of the lift well, a first fixed point and a second fixed point are disposed for fixation of the two ends of the upper wire rope respectively, and the first fixed point is located above the counterweight device and the second fixed point is located above the lift car;

the upper wire rope starting from the first fixed point passes through the upper counterweight wheel, the upper guide pulley, the upper traction wheel and the upper lift car wheel successively and stops at the second fixed point.

As an embodiment, the bottom traction system further comprises: a bottom lift car wheel and a bottom counterweight wheel, wherein:

the bottom lift car wheel is installed on the bottom of the lift car;

the bottom counterweight wheel is installed on the bottom of the counterweight device;

on the bottom of the lift well, a third fixed point and a fourth fixed point are disposed for fixation of the two ends of the bottom wire rope respectively, and the third fixed point is located below the counterweight device and the fourth fixed point is located below the lift car;

the bottom wire rope starting from the third fixed point passes through the bottom counterweight wheel, the bottom guide pulley, the bottom traction wheel and the bottom lift car wheel successively and stops at the fourth fixed point.

Furthermore, the upper traction wheel is located above the upper guide pulley, and the bottom traction wheel is located below the bottom guide pulley.

Furthermore, the upper traction wheel and the upper guide pulley are in the same horizontal plane, and the bottom traction wheel and the bottom guide pulley are in the same horizontal plane.

Furthermore, the upper traction wheel is located below the upper guide pulley, and the bottom traction wheel is located above the bottom guide pulley.

Due to the application of the above-mentioned technical solutions, the present invention has the following advantages and positive effects when compared with current technologies:

1. this invention applies two small-power tractors instead of one high-power tractor, which greatly reduces the cost of electing and using tractor; meantime due to the synchronous operation of the two tractor systems in normal situation, the technology can improve the operation speed of the elevator greatly, to realize the high-speed operation of the elevator.

2. this invention applies the mode of double-tractor and full-drive, which can effectively reduce the failure rate of traction system and greatly improve the reliability of elevator, and in that way, even one tractor is broken down, the other tractor can be operated as emergency response to ensure the safety.

### BRIEF DESCRIPTION OF THE DRAWINGS

In order to explain the technical solutions of the embodiment in this invention more clearly, a brief introduction is given below to the attached figures which are used in the description of embodiments. It is obvious that the attached figures described below are only some embodiments of this invention, and the technicians in this field can acquire other attached figures according to these attached figures on the premise of not contributing inventive efforts, wherein:

FIG. 1 is a schematic diagram of the integral structure of one type of a high-speed elevator in the background technology;

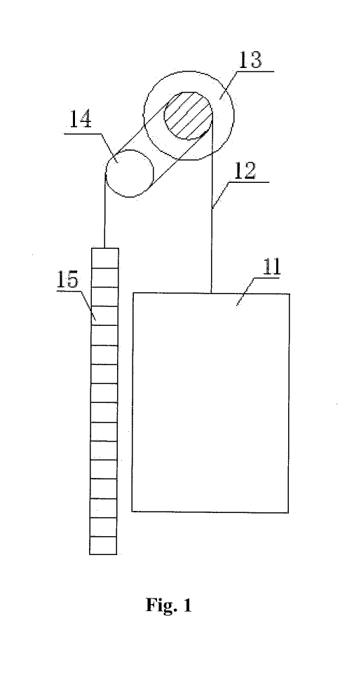

In FIG. 1: 11—a lift car; 12—a wire rope; 13—a traction wheel; 14—a guide pulley; 15—a counterweight device;

FIG. 2 is a schematic diagram of the integral structure of one type of a high-speed and full-drive elevator in Embodiment 1 of this invention;

FIG. 3 is a schematic diagram of the integral structure of another type of high-speed and full-drive elevator in Embodiment 2 of this invention;

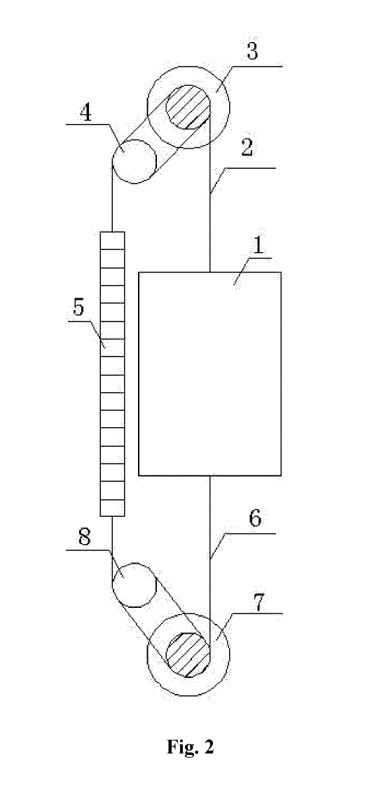

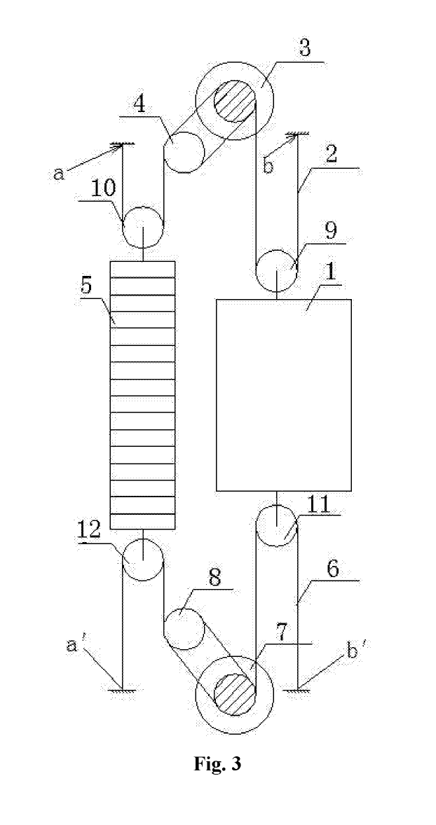

In FIG. 2-3: 1—a lift car; 2—an upper wire rope; 3—an upper traction wheel; 4—an upper guide pulley; 5—a counterweight device; 6—a bottom wire rope; 7—a bottom traction wheel; 8—a bottom guide pulley; 9—an upper lift car wheel; 10—an upper counterweight wheel; 11—a bottom lift car wheel; 12—a bottom counterweight wheel; a—a first fixed point; b—a second fixed point; a′—a third fixed point; b′—a fourth fixed point.

### DESCRIPTION OF EMBODIMENTS

In the following, combining with the attached figures of this invention, a clear and complete description and discussion is made on the technical solution in the embodiment of this invention, and obviously, the embodiments described herein are only some embodiments of this invention instead all of them, and based on the embodiments of this invention, all other embodiments obtained by ordinary technicians in this field on the premise of non-contributing inventive efforts shall belong to the protection scope of this invention.

### Embodiment 1

As shown in FIG. 2, this embodiment discloses a high-speed and full-drive elevator. It applies double-tractor full-drive structure and installed inside a lift well. The high-speed and full-drive elevator comprising: a lift car 1, a counterweight device 5, an upper traction system disposed above the lift car 1 and a bottom traction system disposed below the lift car 1, wherein:

the upper traction system comprises an upper wire rope 2, an upper traction wheel 3 and an upper guide pulley 4, and one end of the upper wire rope 2 is connected with the top of the counterweight device 5, and the other end is connected with the top of the lift car 1 after passing through the upper guide pulley 4 and the upper tractor 3 successively. In this embodiment, the upper traction wheel 3 is located on the top of the lift car 1, while the upper guide pulley 4 is located in the lower left side of the upper traction wheel 3.

The bottom traction system comprises a bottom wire rope 6, a bottom traction wheel 7 and a bottom guide pulley 8, and one end of the bottom wire rope 6 is connected with the bottom of the counterweight device 5, and the other end is connected with the bottom of the lift car 1 after passing through the bottom guide pulley 8 and the bottom tractor 7 successively. In this embodiment, the bottom traction wheel 7 is located on the bottom of the lift car 1, while the bottom guide pulley 8 is located in the upper left side of the bottom traction wheel 7.

Moreover, the upper traction system and the bottom traction system are distributed respectively in the upper and bottom of the lift car 1 in a symmetrical manner; and in normal situation. the upper traction system and the bottom traction system are operated synchronously, to realize high-speed operation of the elevator. Therefore, the two traction systems are disposed separately in the upper and bottom of the lift car 1 in a symmetrical manner, to realize a closed-loop and full-drive structure.

Preferentially, the upper traction system and the bottom traction system are controlled separately by different control systems, and the different control systems are communicated bottom traction system.

Further more, the high-speed and full-drive elevator further comprising a judgment mechanism, the judgment mechanism detects working conditions of the upper traction system. the bottom traction system and the control systems in real time when either of the upper traction system, the bottom traction system and the control systems is malfunctioning, the judgment mechanism controls the corresponding malfunction in traction system or the traction system that corresponding to the malfunctioning control system to be deactivated, and makes another traction system to operate as emergency response. Even one of traction system of the upper traction system and bottom traction system is broken down, the other traction system can be used as the back-up traction system to provide driving force for the elevator, in which way the elevator can still be normally operated.

### Embodiment 2

As shown in FIG. 3, this embodiment discloses another high-speed and full-drive elevator, which contains the followings besides all the parts in embodiment 1:

In a specific way, the upper traction system further comprises an upper lift car wheel 9 and an upper counterweight wheel 10, wherein:

the upper lift car wheel 9 is installed on the top of the lift car 1, which goes up and down along with the lift car 1;

the upper counterweight wheel 10 is installed on the top of the counterweight device 5, which goes up and down along with the counterweight device 5;

on the top of the lift well, a first fixed point a and a second fixed point b are disposed for fixation of the two ends of the upper wire rope 2 respectively, and the first fixed point a is located above the counterweight device 5 and the second fixed point b is located above the lift car 1;

the upper wire rope 2 starting from the first fixed point a passes through the upper counterweight wheel 10, the upper guide pulley 4, the upper traction wheel 3 and the upper lift car wheel 9 successively and stops at the second fixed point b.

In a specific way, the bottom traction system further comprises a bottom lift car wheel 11 and a bottom counterweight wheel 12, wherein:

the bottom lift car wheel 11 is installed on the bottom of the lift car 1, which goes up and down along with the lift car 1;

the bottom counterweight wheel 12 is installed on the bottom of the counterweight device 5, which goes up and down along with the counterweight device 5;

on the bottom of the lift well, a third fixed point a′ and a fourth fixed point b′ are disposed for fixation of the two ends of the bottom wire rope 6 respectively, and the third fixed point a′ is located below the counterweight device 5 and the fourth fixed point b′ is located below the lift car 1;

the bottom wire rope 6 starting from the third fixed point a′ passes through the bottom counterweight wheel 12, the bottom guide pulley 8, the bottom traction wheel 7 and the bottom lift car wheel 11 successively and stops at the fourth fixed point b′.

In this embodiment, the upper traction wheel 3 is located above the upper guide pulley 4, and the bottom traction wheel 7 is located below the bottom guide pulley 8. In this embodiment, the counterweight device 5 is located on the left side of the lift car 1, then, the upper traction wheel 3 is located on the upper right side of the upper guide pulley 4, and the bottom traction wheel 7 is located on the lower right side of the bottom guide pulley 8. On the contrary, if the counterweight device 5 is located on the right side of the lift car 1, then, the upper traction wheel 3 is located on the upper left side of the upper guide pulley 4, and the bottom traction wheel 7 is located on the lower left side of the bottom guide pulley 8. The two modes of setting above are both within the protection scope of this embodiment.

In other embodiments, the upper traction wheel 3 and the upper guide pulley 4 are in the same horizontal plane, and the bottom traction wheel 7 and the bottom guide pulley 8 are in the same horizontal plane. Or, the upper traction wheel 3 is located below the upper guide pulley 4, and the bottom traction wheel 7 is located above the bottom guide pulley 8. The two situations above belong to the technology of different setting positions of the upper traction wheel 3 and the upper guide pulley 4, and the bottom traction wheel 7 and the bottom guide pulley 8, in order to achieve symmetry in the structure of the upper traction system and the bottom traction system, which are both within the protection scope of this invention.

This traction system changes the drive mode of single tractor of traditional high-speed elevator, and it applies double-tractor which are equipped on the upper and bottom of the lift car respectively to realize a closed-loop and full-drive structure, which has the following benefits:
1. this invention applies two small-power tractors instead of one high-power tractor, which greatly reduces the cost of tractor;
2. this invention applies the mode of double-tractor and full-drive which can effectively reduce the failure rate of traction system and greatly improve the reliability of elevator operation, and in that way, even one tractor is broken down, the other tractor can still be effectively operated to ensure the safety.

The contents mentioned above are only better embodiments of this invention, and the protection scope of this invention is not limited herein. Any modification or substitution that can be easily thought of by any technician familiar with this technology within the technical scope disclosed by this invention shall be covered within the protection scope of this invention. Therefore, the protection scope of this invention shall be subject to the protection scope as required in the claim.

1. A high-speed and full-drive elevator, which applies double-tractor full-drive structure and installed inside a lift well, comprising:
a lift car;
a counterweight device;
an upper traction system disposed over the lift car and a bottom traction system disposed below the lift car, wherein:
the upper traction system comprises an upper wire rope, an upper traction wheel and an upper guide pulley; one end of the upper wire rope is connected with the top of the counterweight device, and the other end is connected with the top of the lift car after passing through the upper guide pulley and the upper tractor successively;
the bottom traction system comprises a bottom wire rope, a bottom traction wheel and a bottom guide pulley; one end of the bottom wire rope is connected with the bottom of the counterweight device, and the other end is connected with the bottom of the lift car after passing through the bottom guide pulley and the bottom tractor successively; wherein,
the upper traction system and the bottom traction system are distributed respectively in the upper and bottom of the lift car in a symmetrical manner;
and in normal situation, the upper traction system and the bottom traction system are operated synchronously, to realize high-speed operation of the elevator.

2. The high-speed and full-drive elevator of claim 1, wherein the upper traction system and the bottom traction system are controlled separately by different control systems, and the different control systems are communicated through optic cable, to control the synchronous operation of the upper traction system and the bottom traction system.

3. The high-speed and full-drive elevator of claim 1, wherein the upper traction system further comprises: an upper lift car wheel and an upper counterweight wheel, wherein:
the upper lift car wheel is installed on the top of the lift car;
the upper counterweight wheel is installed on the top of the counterweight device;
on the top of the lift well, a first fixed point and a second fixed point are disposed for fixation of the two ends of the upper wire rope respectively, wherein the first fixed point is located above the counterweight device and the second fixed point is located above the lift car;
the upper wire rope starting from the first fixed point passes through the upper counterweight wheel, the upper guide pulley, the upper traction wheel and the upper lift car wheel successively and stops at the second fixed point.

4. The high-speed and full-drive elevator of claim 1, wherein the bottom traction system further comprises a bottom lift car wheel and a bottom counterweight wheel, wherein:
the bottom lift car wheel is installed on the bottom of the lift car;
the bottom counterweight wheel is installed on the bottom of the counterweight device;
on the bottom of the lift well, a third fixed point and a fourth fixed point are disposed for fixation of the two ends of the bottom wire rope respectively, and the third fixed point is located below the counterweight device and the fourth fixed point is located below the lift car;
the bottom wire rope starting from the third fixed point passes through the bottom counterweight wheel, the bottom guide pulley, the bottom traction wheel and the bottom lift car wheel successively and stops at the fourth fixed point.

5. The high-speed and full-drive elevator of claim 1, wherein the upper traction wheel is located above the upper guide pulley and the bottom traction wheel is located below the bottom guide pulley.

6. The high-speed and full-drive elevator of claim 1, wherein the upper traction wheel and the upper guide pulley are in the same horizontal plane, and the bottom traction wheel and the bottom guide pulley are in the same horizontal plane.

7. The high-speed and full-drive elevator of claim 1, wherein the upper traction wheel is located below the upper guide pulley and the bottom traction wheel is located above the bottom guide pulley.

8. The high-speed and full-drive elevator of claim 1, wherein further comprising a judgment mechanism, the judgment mechanism detects working conditions of the upper traction system, the bottom traction system and the control systems in real time; when either of the upper traction system, the bottom traction system and the control systems is malfunctioning, the judgment mechanism controls the corresponding malfunctioning traction system or the traction system that corresponding to the malfunctioning control system to be deactivated, and makes another traction system to operate as emergency response.
